(19) United States
(12) Patent Application Publication
(10) Pub. No.: US 2019/0204643 A1
(43) Pub. Date: Jul. 4, 2019

(54) Dynamic LCD Screen

(71) Applicant: Jeffrey Paul Overall, Fountain Valley, CA (US)

(72) Inventor: Jeffrey Paul Overall, Fountain Valley, CA (US)

(21) Appl. No.: 15/862,002

(22) Filed: Jan. 4, 2018

(51) Int. Cl. G02F 1/1333; G06F 3/0481; G06F 3/041; H04M 1/725; H04N 5/232

(52) U.S. Cl. CPC G02F 1/13338; G06F 3/04817; H04N 5/23203; G06F 3/0416; H04M 1/72533; G06F 3/0412

(57) ABSTRACT

Devices and methods for improving image capture with portable electronic devices (“PED”). A remote controller with a flat-panel display functioning as a control and display interface for image data captured by the PED. A case for smart phones and other PED may provide a coupling means to removably couple the remote. The flat-panel display may utilize Liquid Crystal Display (“LCD”) or other flat-panel display technology. A mechanical hinge may be used to orient the LCD interface relative to the case, allowing users to view recorded footage while phone is in different positions. The LCD display screen contains command icons on the user interface to allow command input. The LCD remote is capable of data transmission and reception, allowing remote image capture with a smartphone or other PED.

### FIELD OF INVENTION

The present invention relates to image display and remote image capture with portable electronic devices.

### BACKGROUND OF THE INVENTION

Digital convergence has resulted in cameras being integrated into multipurpose digital devices. Portable electronic devices (“PED”), such as smartphones, are now widely used for photography and videography. Image and audio capturing capability is increasing rapidly, ensuring continued prevalence of smartphones and other PED use in photography and videography.

PED's are predominantly shaped like tablets, with rectangularly shaped front and back planar surfaces connected by four relatively shorter peripheral sides. PED's traditionally have one or more integrated cameras on the back and possibly front (relative to the user) surfaces of the camera. The flat, user facing interface of the device functions as a flat-panel display of captured image data and provides command icons, or command buttons, allowing input of command data to control settings and functionality of the camera or other applications. This arrangement allows adequate control when capturing images from a basic vantage point, such as selfies captured by extending the arm perpendicular to the torso or outward shots taken at eye level. However, the PED must often be positioned at a vantage point where the flat-panel display screen interface cannot be viewed. Images must be captured blind and adjustments made based on what is already captured. This requires extra work, is time consuming and can cause a user to miss the opportunity to capture a transitory scene. Location of the input command icons must be guessed at or detected tactilely. This can lead to delays and mistakes in manipulating the settings the camera and capturing the scene. Sub-optimal ergonomics may result from hand and wrist contortion needed to reach the command icons while positioning the camera lens.

Further obstacles limit remote photography with a PED and a user's ability to remotely capture footage of themselves. Timing applications exist, allowing a camera to be placed remotely to capture pictures and video clips of a preset duration. But the camera must be retrieved after each recording and manually reset. The user does not have control and is not able to view the images the camera is recording when it is remotely placed, preventing real-time adjustments and hindering image capture.

The present invention provides a means of viewing the display of a PED camera from different vantage points. In an exemplary embodiment an LCD remote is removably hinged to a case and capable of rotating relative to the phone in multiple directions. This enables visibility of the screen from multiple vantage points relative to the user. The user can access the image capturing command icons while holding the device in the most ergonomically advantageous position. The screen can be locked in a wide range of angles relative to the case, allowing ergonomically optimal input of the command icons. The screen contains an interface allowing control of camera settings and image capturing command icons.

The device can be detached from the case and serve the dual functions of remote controller and display screen. This allows a user to mount the camera remotely and alter the scene or camera setting based on the real-time display, to capture the ideal image. Corrections can be made in real-time, prior to the photograph being taken. Multiple photographs or video scenes can be taken without having to retrieve and manually reset the camera.

### SUMMARY

A case may be configured to removably couple with an array of PED's. An exemplary case embodiment is configured to couple a smartphone. An exemplary remote utilizes an LCD flat-panel display interface and is referred to as an remote. Coupling mechanisms for the LCD remote are integrated into the case. The case is composed of polycarbonate or other durable material. The case has a recessed bed configured to receive the LCD remote. The recessed bed is positioned on the planar back surface of the case.

The case partially encloses the smartphone or other type of PED. The side opposing the recessed bed is partially open to allow access to the coupled smart phone's interface. The exemplary embodiment uses flexural rigidity to couple the phone. Flexural rigidity provides tolerancing enabling a case to couple with PED's within a predetermined dimension range. The case has may have a lens opening for exposure of the back-facing smartphone camera lens facing way from the smartphone interface.

An exemplary case has four case coupling elements, one positioned on each peripheral side of a recessed bed. Alternating recessed and protruding sectors comprise the case coupling elements. Four corresponding screen coupling elements are present on the sides of the a remote. All four of the case and screen coupling elements can be engaged to couple the remote. Individual corresponding case and screen coupling elements can also be engaged to create an operative hinge. Alternative embodiments may comprise a different number of coupling elements capable of operatively coupling a remote with a case. Operative coupling is used herein to denote coupling of multiple component that allows movement of those components while coupled.

The remote is configured to fit into the recessed bed. The remote has an interface on one planar surface. Image data may be displayed, and command functions may be input via the interface. Input command icons enable the user to enter commands based on the images transmitted from the image capturing smartphone and displayed on the interface. The interface has touchscreen capability; it is receptive to finger, stylus or any other force or haptic communication of Aperture, shutter speed, zooming, and other camera settings and functions maybe adjusted via the interface command icons. The exemplary interface may be a liquid crystal display (“LCD”). The exemplary interface may contain a shutter command icon, allowing input of image capture command, or control of video recording. The interface automatically adjusts to orient relative to the user, allowing the user to view image data and command icons in an upright—relative to the user—position.

In the exemplary embodiment, when all four sides of case coupling and screen coupling mechanisms are engaged, the LCD interface lays just below the surface of the case in a storage position to protect the interface from contact. When the case coupling mechanisms are coupled with the screen coupling mechanisms the LCD remote can be rotated relative to the case in four directions; around the planar horizontal and vertical axes of the case. From the storage position the LCD remote can detach from three elements of the case coupling mechanisms and rotate relative to the case coupling mechanism to which it remains attached. When a single case coupling mechanism is coupled to a single remote coupling mechanism an operative hinge is created. The screen can be rotated around an axis created by an operative hinge to allow the user to view recorded image data when the display of the smartphone cannot be viewed because of the required orientation of the camera to capture the image. The exemplary operative hinge is capable of locking at various angles relative to the camera. This enables the screen to be locked and stabilized at the desired viewing angle.

When detached, the LCD remote functions as a wireless remote controller. Camera settings and function can be adjusted remotely. As when the LCD remote is coupled with the case, the command icons are used to control camera function. The LCD remote has an uplink transmission component capable of transmitting command data to a coupled image capturing device, such as a smartphone or other PED with image capture capability. It also has a downlink receiver component capable of receiving and processing data from a coupled image capturing device.

Alternative embodiments may have three or fewer hinges. It may be desirable to prevent the LCD remote from swinging toward the back-facing camera. Having a hinge or hinges only permitting rotation around the horizontal or vertical axis may achieve this. Some embodiments may utilize biaxial hinges to allow the rotation of the screen around the vertical and horizontal axis from the same coupling point. An exemplary embodiment includes a biaxial hinge along one or both peripheral walls of the coupling bed. Alternative embodiments may permit the display LCD control interface to face into the case bed when coupled. This may allow greater protection of the glass surface of the LCD interface. When rotated around the hinging mechanism the screen would open out to the user. In alternative embodiments the LCD remote may only act as a remote controller. The case would still permit coupling of the LCD remote, but the hinging mechanism would not be present. The case could be configured to allow the LCD remote to slidably attach. Other viable coupling means may also be utilized. In the non-hinging embodiments of the case would still function as a convenient storage module for the LCD remote.

The LCD remote may be coupled directly with the permanently attached case or covering of the phone. The case coupling mechanism may be permanently integrated into the planar surface opposing the interface of the phone. The LCD remote may be coupled magnetism, snap-hooking, latching or hinging as in the exemplary case embodiment.

The exemplary embodiment uses LCD as the electronic display because it is currently the most common active mode of flat-panel display. Other types of electronic displays, such as LED, with touchscreen capability may be used for the control interface.

### BRIEF DESCRIPTION OF DRAWINGS

FIG. 1 shows a front view of the protective case and LCD remote uncoupled.

FIG. 2A shows a perspective view of the LCD remote inserted into the case bed and operative hinges engaged

FIG. 2B shows a perspective view of the LCD remote rotated relative to the a vertical axis of the case.

FIG. 2C shows a perspective view of the LCD remote rotated relative to the a horizontal axis of the case.

FIG. 3 shows a back view of the case and front view of the coupled smartphone.

FIG. 4 shows a schematic view of the detached LCD remote functioning as a remote controller of the coupled smartphone camera.

### DRAWING NUMERALS

10 PED
20 Case
22 Case Bed
24 Case Coupling Mechanism
30 LCD Remote
31 Periphery Sidewall
32 Screen Coupling Mechanism
34 Control Interface
35 Command Icons
36 Image Display
40 Operative Hinge
52 Lens Opening
54 Base Device Interface
56 Base Device Display
58 Base Command Icon
60 Back Facing Camera Lens
62 Front Facing Camera Lens
72 Command Data
74 Image Data
80 Vertical Axis
82 Horizontal Axis

### DETAILED DESCRIPTION OF DRAWINGS

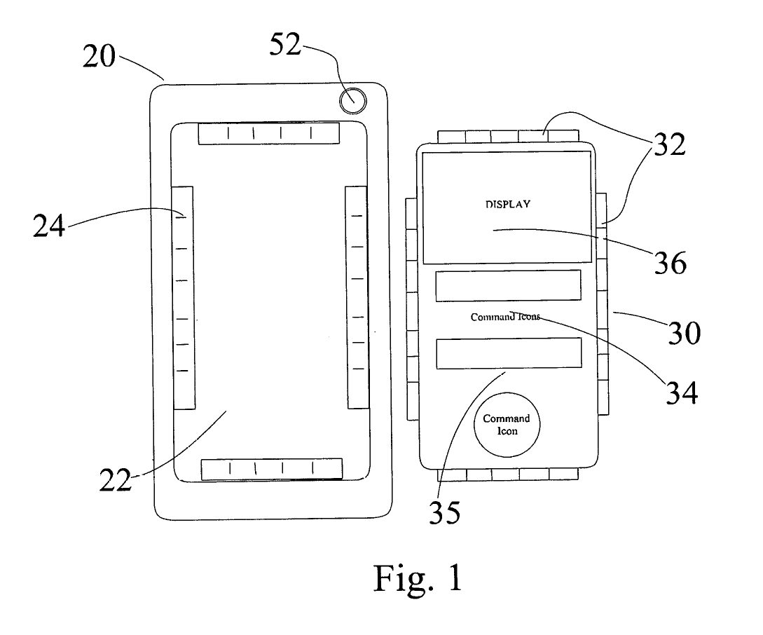

FIG. 1 shows a dynamic LCD remote 30 detached from a protective case 20. The exemplary case 20 is configured to receive and securely couple a smartphone or other PED. Flexural rigidity, snap-hooking, clamping, or any other coupling means known in the art may be utilized. The case is composed of polycarbonate, rubber, elastomeric or other durable material permitting shock absorption and augmenting protection of the coupled device. The case is configured to couple devices with dimensions within a certain range.

A lens opening 52 aligns with the optical path of a smartphone camera lens and permits image capture of the entire camera spectrum. A case bed 22 is configured to receive an LCD remote 30. Four case coupling mechanisms 24 are attached to the periphery sidewalls 31 of the bed 22. The bed 22 is positioned in relation to the lens opening 52 to prevent obstruction of the camera's field of view when the LCD remote 30 is attached. The case coupling mechanisms 24 have alternating protruding notch and recessed receptive sections. Four corresponding screen coupling mechanisms 32 are attached to the sides of the LCD remote 30 configured to align with periphery sidewalls 31 when the LCD remote 30 is installed into the case bed 22. The screen coupling mechanisms 32 have complementary alternating protruding notch and recessed receptive sections enabling removable coupling with the case latching mechanisms 24. The relatively longer case coupling mechanisms 32 create two potential vertical axes 80 and two potential horizontal axes 82 for a coupled LCD remote to rotate around.

The LCD remote 30 has a control LCD interface 34. The LCD interface 34 serves as the flat-panel display in this embodiment. The exemplary LCD interface 34 provides an image display 36 section and command icon section 35 allowing input of image capturing shutter command and alteration of other camera settings based on the image display 36. The command icons 35 and image display 36 can be displayed simultaneously, as shown here, or can be expanded to cover the entire screen. The exemplary LCD interface 34 is touchscreen capable and operated by hand.

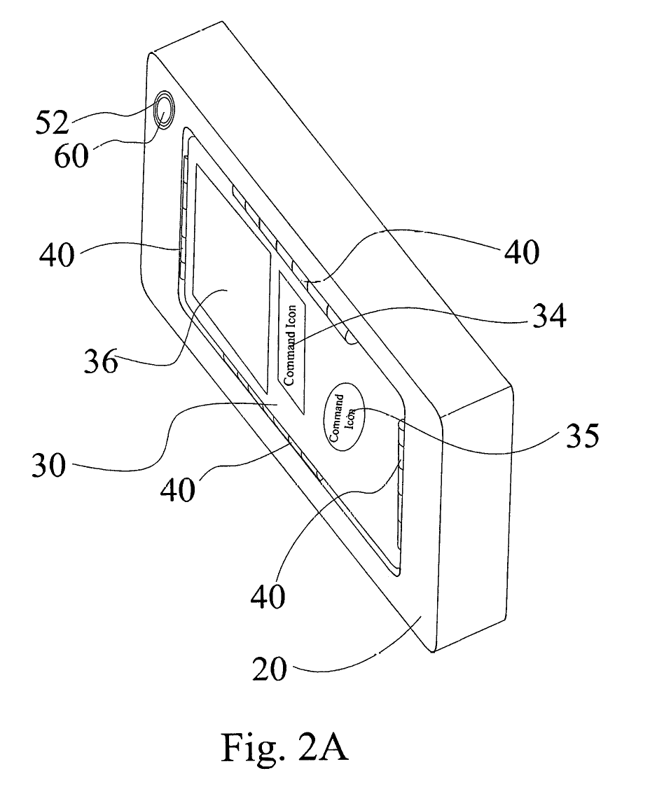

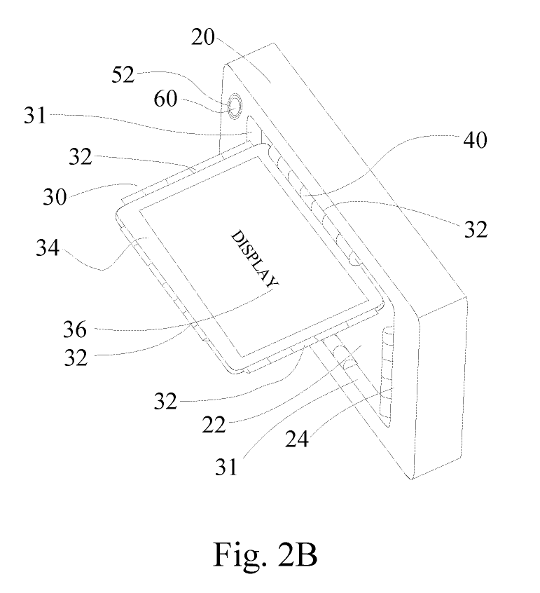

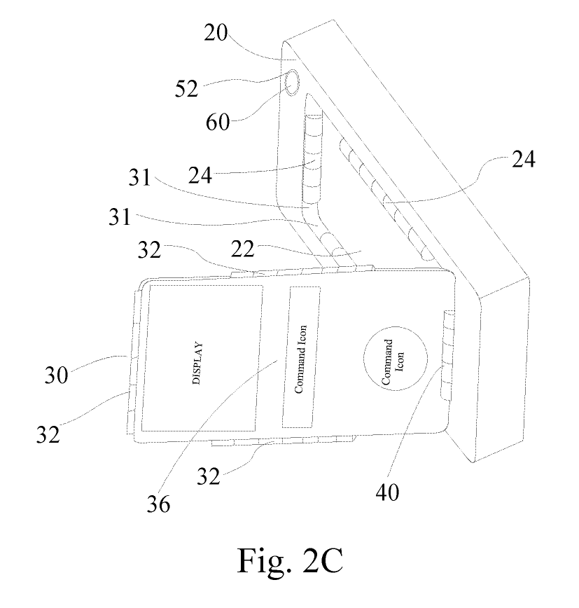

FIG. 2A shows the LCD remote 30 coupled with the case 20. The engaged coupling mechanisms form operative hinges 40 when pressure fitted. When all four operative hinges 40 are engaged the back of the LCD remote 30 abuts the case bed 22. The LCD remote 30 is locked in place and the control interface 34 is positioned slightly below the surface of the case 20 to protect against damage from contact. The LCD remote 30 is wirelessly communicatively coupled to the smartphone to permit transmission and reception of both command data and image data. The LCD remote 30 can be stored in this position or used to display and command the phone camera on the side opposing the smartphone interface. The lens opening 52 allows exposure of the back-facing camera 60 of the smartphone. Alternatively, the LCD remote 30 may be installed with the control interface 34 facing inward, toward the case bed 22. This protective orientation may be optimal for protection of the control interface, when viewing of captured image data is not required.

Wireless communication can be achieved by any viable means (radio, Wi-Fi®, Infrared, etc.). In the exemplary embodiment the smartphone and dynamic LCD remote 30 wirelessly transmit data by Bluetooth® technology. The LCD remote 30 contains a Bluetooth® enabled module allowing transmission of the command and image data.

FIG. 2B shows the LCD remote 30 rotated around a vertical axis 80 of the case 20. The LCD remote 30 is locked in a position with the LCD interface 34 roughly perpendicular to the back planar surface of the case 20 by the engaged operative hinge 40, allowing orientation of the camera lens 60 and operation of the control interface 34. The other three screen coupling mechanisms 32 are disengaged if the user begins from the stored locking position in FIG. 2A or screen coupling mechanism 32 for the desired operative hinge is individually engaged if the user is starting with the remote detached. The screen in the exemplary embodiment is capable of automatically orienting the control interface 34 vertically or horizontally, based on relation to the user. This control interface 34 orientation may be beneficial when the user wishes to take a landscape picture or video from a relatively low vantage point. The command icons provided 35 on the screen interface 34 allow ergonomically ideal operation. The display of the image data captured by the camera allows more accurate image capture and quicker calibration. The image display 36 is expanded to cover most of the LCD interface 34. Expansion of the image display 36 may allow closer scrutiny of image data detail. The command icons 35 and image display 36 can be configured to allow efficient operation of the LCD interface 34.

FIG. 2C demonstrates rotation of the LCD remote 30 around a horizontal axis 82 of the case 20. The locking strength of the operative hinge 40 allows a user to position the LCD remote 30 at a desired angle relative to the screen. The back facing camera lens 60 can be situated at an angle relative to the LCD remote 30 that is most beneficial for desired image capture. In this embodiment the LCD interface 34 faces away from the case 20 when coupled. In other embodiments the screen may face toward the case 20 or the coupling mechanisms 24, 32 may permit control interface 34 to be coupled facing either away from or toward the case.

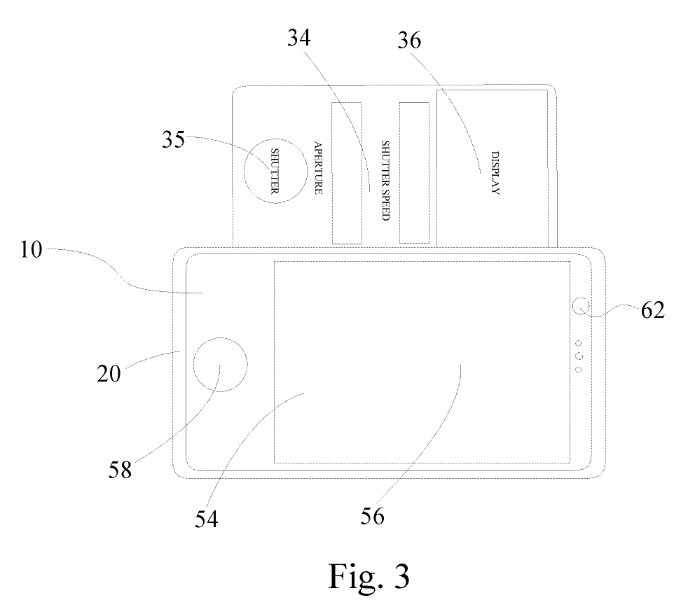

FIG. 3 shows a case 22 coupled with a PED 10. The exemplary PED 10 is a smartphone interface 54 and demonstrates the rotation range of the coupled LCD remote 30. The exemplary smartphone interface 54 also has an image capture device, or front facing lens 62 on the side opposing the front of the case 20. The LCD remote 30 can be wirelessly communicatively coupled with the front lens 62, allowing image capture from either side of the phone. The exemplary smartphone has an interface 54 with command icons 58 and display 56 capabilities similar to the LCD remote 30 control interface 34.

Utilization of the smartphone interface commands while viewing the LCD remote 30 interface is possible, if this permits the most advantageous viewing of the captured image. The screen interface 34 command icons 35 and image display 36 can be configured specifically for image capture and control of camera settings, making use of them more efficient than the multipurpose smart phone interface 54.

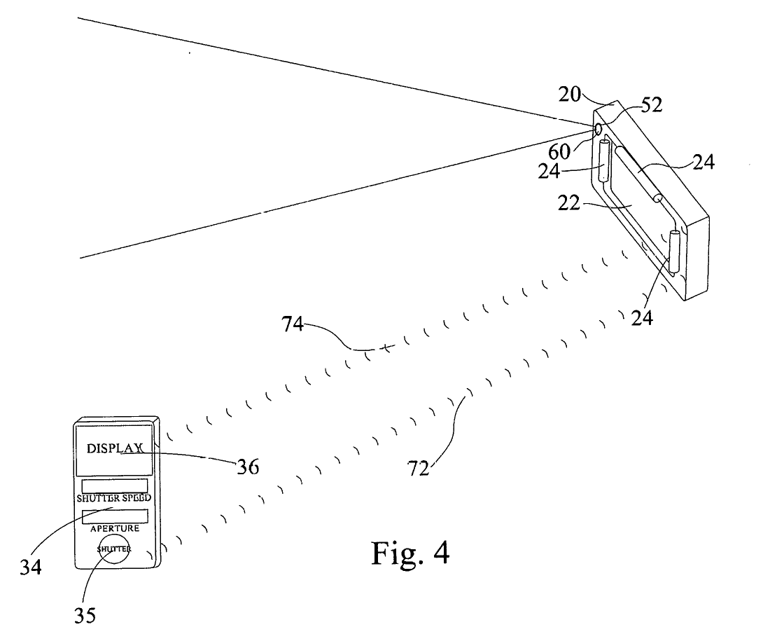

FIG. 4 demonstrates the data transmission process when the LCD remote 30 is detached and utilized as a remote controller for a smartphone camera. The A case 20 with a coupled smartphone (not shown) is positioned remotely from the user. The LCD remote 30 is wirelessly communicatively coupled with the smartphone. Command data 72 is transmitted from the LCD remote 30 to the coupled smartphone. Image data 74 captured with the back-facing camera lens 60 is transmitted from the smartphone to the LCD remote 30. A processing module in the LCD remote 30 can receive the image data and process it for display. The command icons 35 enable image capture and adjustments based on the image data on the image display 36. As stated earlier, Bluetooth® technology is utilized for wireless communication in the exemplary embodiment.

The user can take self-portraits or mount the camera at a vantage point that would not be possible through handheld photography. Multiple pictures can be taken remotely because the screen interface 34 is capable of setting and adjusting the camera. For example, the user can be positioned to view the process of an object that will emerge and activate a shutter command when image capture is most advantageous. This would not be possible if the user was required to activate or reset the camera by direct contact.

The foregoing discussion discloses and describes merely exemplary methods and embodiments. As will be understood by those familiar with the art, the disclosed subject matter may be embodied in other specific forms without departing from the essence or characteristics thereof. Accordingly, the foregoing disclosure is intended to be illustrative, but not limiting, of the scope of the invention, which is set forth in the following claims.

1. Method of remotely taking pictures with Portable Electronic Device (“PED”), comprising:
a. a case capable of coupling a PED, said case comprising at least two case coupling components;
b. an LCD remote, said LCD remote comprising at least two screen coupling components configured to operatively couple with the case coupling components and form at least two hinges;
c. said case capable of coupling a PED and an LCD remote;
d. said hinges capable of individually or jointly coupling the LCD remote, said hinges enabling rotation of a coupled LCD remote around at least two axes;
e. said PED comprised of a camera and module enabling wireless communication;
f. said LCD remote capable of wireless communicative coupling with the PED;
g. said LCD remote comprised of a module capable of wirelessly receiving image data from the PED and transmitting command data wirelessly to said PED;
h. the LCD remote comprised of a user interface permitting display of image data and command icons as means of remotely controlling the PED camera.

2. A remote control for a camera phone, comprising:
a. a flat-panel display with touchscreen capability comprised of at least one coupling mechanism and module capable of data transmission, reception, and processing;
b. a case configured to removably couple couple a phone with image capturing capability;

3. The remote control in claim 2, wherein the coupled coupling mechanisms form a locking hinge.

4. A phone case with a detachable remote controller, comprising:
a. a case capable of detachably coupling a smartphone;
b. said case having a recessed bed configured to receive an LCD screen, said recessed bed located on the case's largest planar surface;
c. a remote controller configured to fit into the recessed bed, comprising;
i. an LCD touchscreen interface,
ii. a module permitting data transmission, reception, and processing,
iii. four screen coupling mechanisms aligning with the case coupling mechanisms and capable of operative coupling with all four or one coupling mechanism,
iv. Said coupling mechanisms creating a hinge allowing rotation of the remote controller relative to the phone case;
d. said remote controller comprising a means of wirelessly communicating with a coupled smartphone.

5. A method of remotely capturing image data with a Portable Electronic Device, comprising:
a. a remote controller comprised of an LCD touchscreen interface and Bluetooth® module;
b. a case capable of coupling a PED and removably coupling the remote controller;
c. said PED comprised of a camera and Bluetooth® module;
d. said remote controller capable of displaying image data recorded by the PED.

6. A smartphone capable of remote capture of image data, comprising:
a. case coupling means integrated with the back planar surface opposing the smartphone interface;
b. a remote controller configured to couple with case coupling means, said remote controller comprised of:
i. A flat-panel display capable of image display and command input,
ii. A module capable of data transmission, reception and processing.

7. A smartphone capable of remote capture of image data, comprising:
a. case coupling means integrated with the back planar surface opposing the smartphone interface;
b. a remote controller configured to couple with case coupling means, said remote controller comprised of:
i. A flat-panel display capable of image display and command input,
ii. A module capable of data transmission, reception and processing.
